(19) United States
(12) Patent Application Publication
(10) Pub. No.: US 2007/0223226 A1
(43) Pub. Date: Sep. 27, 2007

(54) Light Emitting Diode Illuminating Apparatus and Method of Manufacturing the Same

(76) Inventor: Dong Wook Park, Gwangsan-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/691,613

(22) Filed: Mar. 27, 2007

(30) Foreign Application Priority Data
Mar. 27, 2006 (KR) 10-2006-0027674

(51) Int. Cl. F21V 31/00; F21V 21/00; F21V 15/00

(52) U.S. Cl. 362/267; 362/249; 362/377

(57) ABSTRACT

Embodiments of a light emitting diode (LED) illuminating apparatus and a method of manufacturing the same are provided. An LED illuminating apparatus can include a substrate, at least one LED mounted on the substrate, and a moisture-proof coating layer formed around the at least one LED. A method of manufacturing an LED illuminating apparatus can include mounting at least one LED on a substrate and forming a moisture-proof coating layer around the at least one LED.

### CROSS-REFERENCE TO RELATED APPLICATIONS

The present application claims the benefit under 35 U.S.C. §119 to Korean Patent Application No. 10-2006-0027674, filed Mar. 27, 2006, which is hereby incorporated by reference in its entirety.

### BACKGROUND

1. Field of the Invention

The present invention relates to a light emitting diode illuminating apparatus and a method of manufacturing the same.

2. Description of Related Art

In general, illuminating apparatuses are provided in parks, roads, and walls or columns of buildings to illuminate a peripheral space.

In addition, because the inside of an apparatus, such as a refrigerator or a dish washer, is dark, an illuminating apparatus is typically provided to illuminate the inner space of the apparatus by turning on whenever a user puts something in the apparatus or takes something out of the apparatus.

In general, a filament bulb is used as the illuminating apparatus for illuminating inside a refrigerator. An illuminating apparatus for a refrigerator that uses such a filament bulb may have the following problems.

In particular, since the life span of a filament bulb is short, the bulb must be frequently exchanged. In addition, a filament bulb may consume a great amount of power.

A significant amount of heat may be generated by the filament bulb when light is emitted from the filament bulb. Accordingly, such heat may affect, for example, articles located in a refrigerator. Therefore, the bulb must be separated from the articles.

Furthermore, because a metal part formed in the filament bulb is exposed to cold air and moisture in a refrigerator, the metal part may corrode so that an electrical short or disconnection is generated. In addition, the filament bulb may break due to contact between the surface of the heated bulb and the moisture in the refrigerator.

Due to the problems of the filament bulb, research on an illuminating apparatus for providing light in a humid space, such as the inside of a refrigerator, is being performed.

### BRIEF SUMMARY

An embodiment of the present invention provides a light emitting diode (LED) illuminating apparatus suitable for a humid space or place, and a method of manufacturing the same.

An embodiment of the present invention provides an LED illuminating apparatus in which moisture-proof coating layers can be formed in regions where LEDs are mounted, and a method of manufacturing the same.

An embodiment provides a light emitting diode (LED) illuminating apparatus, comprising: a substrate, at least one LED mounted on the substrate, and moisture-proof coating layers formed outside of the at least one LED.

An embodiment provides a method of manufacturing an LED illuminating apparatus, comprising: mounting at least one LED on a substrate and forming moisture-proof coating layers around the at least one LED.

### BRIEF DESCRIPTION OF THE DRAWINGS

FIG. 1 is a side sectional view of a refrigerator in which a light emitting diode (LED) illuminating apparatus according to an embodiment of the present invention is provided;

FIG. 2 is a plan view illustrating an LED illuminating apparatus according to an embodiment of the present invention;

FIG. 3 is a partial side sectional view of the LED illuminating apparatus according to an embodiment shown in FIG. 2;

FIG. 4 is a sectional view illustrating an LED according to an embodiment of the present invention;

FIG. 5 is a sectional view illustrating an example in which an LED illuminating apparatus according to an embodiment of the present invention is provided;

FIG. 6 is a plan view illustrating an LED illuminating apparatus according to an embodiment of the present invention;

FIG. 7 is a partial side sectional view of the LED illuminating apparatus according to an embodiment shown in FIG. 6; and

FIG. 8 is a sectional view illustrating an example in which the LED illuminating apparatus according to an embodiment of the present invention is provided.

### DETAILED DESCRIPTION

Light emitting diode (LED) illuminating apparatuses according to embodiments of the present invention and methods of manufacturing the same will be described with reference to the attached drawings.

LED illuminating apparatuses according to embodiments of the present invention can be provided in humid and closed spaces such as inside of a refrigerator or a dishwasher, and underground structures such as an underground passage, a subway, a sewer, a tunnel, a manhole, or an underground parking lot.

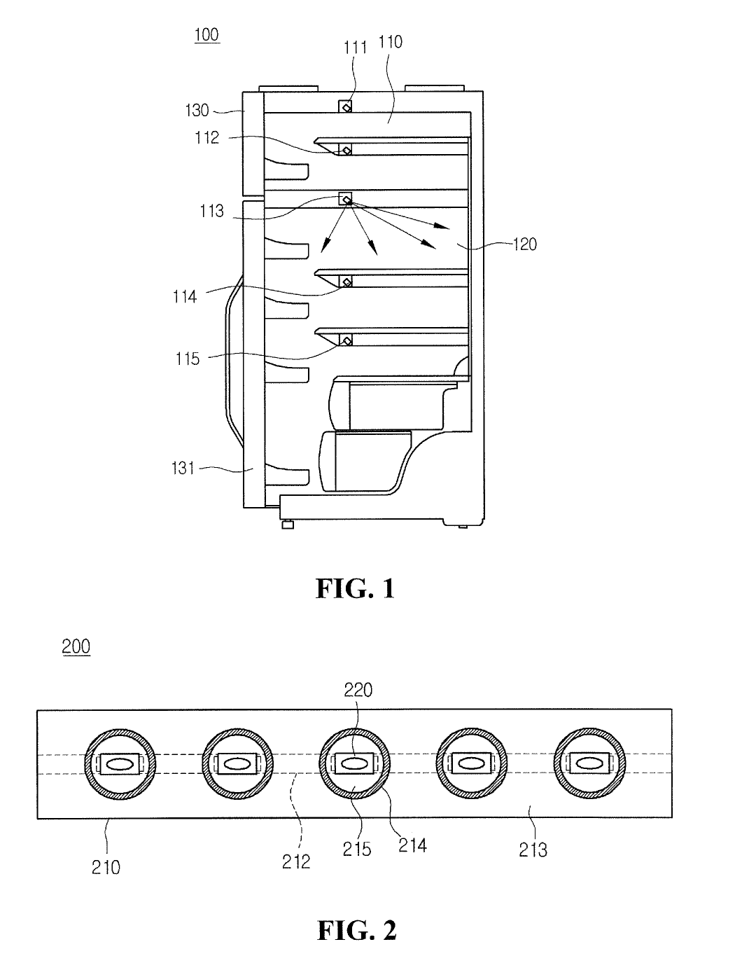

FIG. 1 is a sectional view illustrating a refrigerator in which an illuminating apparatus according to an embodiment of the present invention is provided.

Referring to FIG. 1, in general, a freezer compartment 110 and a refrigerator compartment 120 are provided in the inner space of a refrigerator 100 and the freezer compartment 110 and the refrigerator compartment 120 maintain low temperatures set by a cooling apparatus.

A plurality of illuminating apparatuses 111, 112, 113, 114, and 115 can be provided in the freezer compartment 110 and the refrigerator compartment 120. The illuminating apparatuses 111 and 112 in the freezer compartment can turn on and off as a freezer compartment door 130 is opened and closed. The illuminating apparatuses 113, 114, and 115 in the refrigerator compartment can turn on and off as a refrigerator compartment door 131 is opened and closed.

The illuminating apparatuses 111, 112, 113, 114, and 115 can be realized by a light emitting diode (LED). The LED can be a semiconductor device to which a compound such as GaN and GaAs or a fluorescent body is added, and may generate light components in white, green, blue, and ultraviolet (UV) ray regions.

An illuminating apparatus using LEDs will be described with reference to preferred embodiments as follows.

### First Embodiment

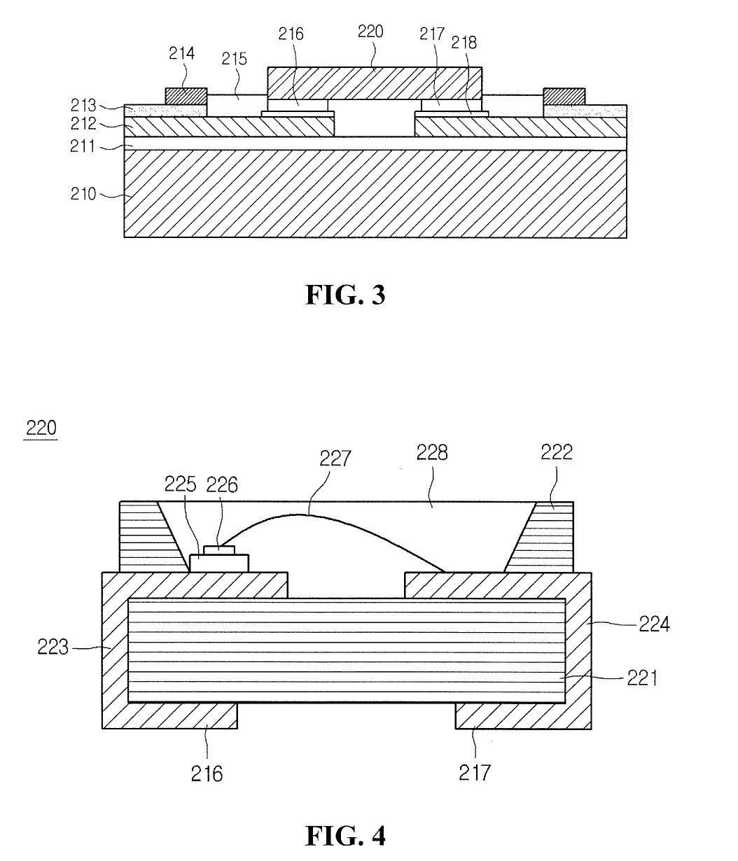

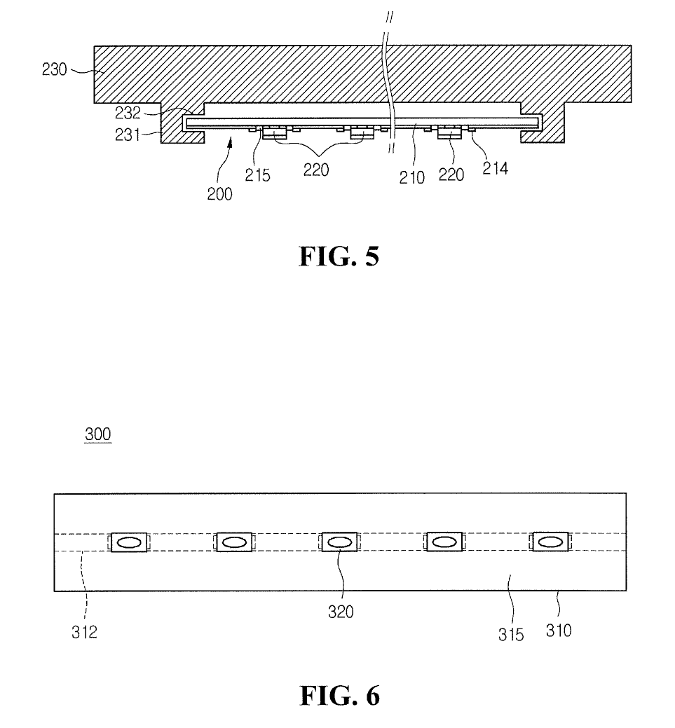

FIGS. 2 to 5 illustrate a first embodiment of the present invention. FIG. 2 is a plan view illustrating an LED illuminating apparatus. FIG. 3 is a partial side sectional view of FIG. 2. FIG. 4 is a sectional view of an LED. FIG. 5 is a sectional view illustrating an illuminating apparatus provided in a structure.

Referring to FIG. 2, an illuminating apparatus 200 can include a substrate 210, lead patterns 212, a solder resist layer 213, barrier ribs 214, moisture-proof coating layers 215, and LEDs 220.

The substrate 210 can be formed of, for example, a metal substrate having an excellent heatproof characteristic, a flame retardant (FR)-4 substrate, or a common printed circuit board (PCB). In various embodiments, the substrate 210 can be bar-shaped or curved.

The lead patterns 212 can be formed on the substrate 210. The lead patterns 212 can be formed of metal having an excellent electrical characteristic (such as copper clad laminates) to electrically connect the LEDs to each other.

The solder resist layer 213 can be a photo solder resist (PSR) layer. The solder resist layer 213 can be coated with insulating ink in order to protect the surface of the substrate and to insulate the circuit patterns from each other. The insulating ink can protect the lead patterns 212 and the surface of the substrate.

The barrier ribs 214 can be formed to have a height by which the moisture-proof coating layers 215 around the LEDs 220 do not overflow. The barrier ribs 214 can be formed of circular or polygonal closed loops. The barrier ribs 214 can be formed by, for example, a silk screen printing method.

The moisture-proof coating layers 215 can be formed of a moisture-proof coating material such as epoxy or silicon resin. The moisture-proof coating material can be injected within the barrier ribs by a dispensing method to be molded. The moisture-proof coating layers 215 can be molded to a predetermined thickness on metal parts having an electrical characteristic between the LEDs 220 and the substrate 210.

At least one LED 220 can be bonded to the lead patterns 212 on the substrate 210 by a surface mounting technology (SMT). In addition, the LEDs 220 can be arranged on the substrate 210 in at least one column and/or row and can be arranged in series or in parallel by the lead patterns.

The LEDs 220 are not necessarily arranged in columns or rows and the distance between the columns and/or rows of the LEDs, the number of columns and/or rows of the LEDs, and the shape of the columns and/or rows of the LEDs may vary in accordance with an inner structure.

The LEDs 220 can be selectively realized using red, blue, green and/or white LEDs as desired in accordance with the space or place where the LEDs 220 are to be provided.

Referring to the illuminating apparatus 200, the barrier ribs 214 can be formed around the LEDs 220 and the moisture-proof coating layers 215 can be locally molded between the LEDs 220 and the barrier ribs 214 so that it is possible to inhibit the parts having the electrical characteristic of the LEDs 220 or the lead patterns 212 from being exposed to the outside.

FIG. 3 is a partial sectional view of an illuminating apparatus.

Referring to FIG. 3, a pre-preg type insulating layer 211 can be hardened on the substrate 210 by an annealing process at high temperature. Electrically separated lead patterns 212 can be formed on the insulating layer 211. In an embodiment, the lead patterns 212 can be formed by attaching copper clad laminates to the insulating layer 211, attaching a photosensitive dry film to the copper clad laminates by heat and pressure, and performing exposure, development, and etching processes to form desired lead patterns 212.

The substrate 210 can be formed of a metal substrate (for example: aluminum) having an excellent heat proof characteristic. In another embodiment, the substrate can be an FR-4 substrate. Here, when the FR-4 substrate is used, the lead patterns can be formed on the substrate without forming the insulating layer 211.

Solder resist layers 213 can be formed on the lead patterns 212 and the substrate. Barrier ribs 214 in the form of closed loops can be formed on the solder resist layers 213. In a specific embodiment, the solder resist layers 213 can be partially etched in order to mount the LEDs 220 and expose the lead patterns 212.

The barrier ribs 214 can be formed having a height sufficient for preventing the moisture-proof coating layers 215 from overflowing. A silk screen process can be used to form the barrier ribs 214. The thickness of the barrier ribs 214 can be determined based on viscosity and the amount of coating of the moisture-proof coating layers 215. The barrier ribs 214 can have various enclosed shapes such as a circle or a polygon.

The LEDs 220 can be provided in a package form and mounted to electrode terminals 216 and 217 by SMT. In an SMT process, the electrode terminals 216 and 217 of the LEDs 220 can be arranged on the lead patterns 212 by dispensing solders 218 and melting the solders 218 by heat to electrically connect the electrode terminals 216 and 217 and the lead patterns 212 to each other. A reflow heating apparatus can be used to heat the solder 218.

In addition, moisture-proof coating layers 215 can be formed between the barrier ribs 214 and the LEDs 220. The moisture-proof coating layers 215 prevent the lead patterns 212 in the barrier ribs, the electrode terminals 216 and 217 of the LEDs 220, and the solders 218 from being exposed to the outside. Here, the moisture-proof coating layers 215 can be formed to a height lower than that of the barrier ribs 214.

The moisture-proof coating layers 215 can be formed of a moisture-proof or moisture tolerant coating material such as a silicon based resin. The silicon may be locally molded in regions between the LEDs 220 and the barrier ribs 214 using a syringe and can be hardened at a predetermined temperature by a cure process. In another embodiment, the moisture-proof coating layers 215 can be formed of epoxy resin.

Since the moisture-proof coating layers 215 are molded to a height higher than that of the electrode terminals 216 and 217 of the LEDs 220 or an electrode terminal frame, and lower than that of the barrier ribs, it may be possible to inhibit the electrode terminals of the LEDs and the bonded parts of the electrode terminals of the LEDs from being damaged due to outside moisture.

FIG. 4 is a side sectional view of an LED according to an embodiment of the present invention. The LED can have a package structure in which at least one LED chip or at least one type of LED chip is mounted to emit white or colored light.

Referring to FIG. 4, in the LED 220, a cavity can be formed in a reflecting cup 222 on a substrate 221. A plurality of lead frames 223 and 224 can be formed extended from the bottom surface of the cavity to the outside of the substrate 221.

An LED chip 225 can be adhered to the first lead frame 223 by, for example, conductive paste, and an electrode 226 of the LED chip 225 can be connected to the second lead frame 224 by a wire 227. The lower parts of the first and second lead frames 223 and 224 can function as the electrode terminals 216 and 217 of the LED.

Here, the LED chip 225 may be formed as a vertical LED chip or a horizontal LED chip in accordance with a position where the electrode is formed and may be formed by PN, NPN, or PNP semiconductor connections. The LED chip 225 can be mounted on the lead frames selectively using, for example, wire bonding, flip chip bonding, or die bonding.

A mold member 228 can be formed in the cavity of the reflecting cup 222. The mold member 228 can be formed of transparent silicon or epoxy to be flat or have a concave or convex lens shape. In a further embodiment, a fluorescent body that absorbs the light generated by the LED chip 225 for emitting light of a different wavelength can be added to the mold member 228.

The light emitted from the LED chip 225 passes through the transparent mold member 228 to be emitted to the outside and partial light is reflected by the circumference of the cavity to be emitted to the outside.

Here, the moisture-proof coating layers 215 can be molded to a height larger than the lead frames 223 and 224.

FIG. 5 is a side sectional view illustrating an example in which the illuminating apparatus according to the first embodiment of the present invention may be mounted in a structure.

Referring to FIG. 5, an illuminating apparatus 200 can be provided in an inner structure 230 of a refrigerator. Fixed holders 231 can be formed on both sides of the inner structure 230, and grooves 232 can be formed in the fixed holders 231.

Both ends of a substrate 210 of the illuminating apparatus 200 can be coupled with the grooves 232 of the fixed holders 231 so that the illuminating apparatus 200 is coupled with the inner structure 230.

In addition, components (such as a constant current supplying circuit and a controlling circuit) for uniformly supplying a current to the LEDs 220 can be mounted in the illuminating apparatus 200. Moisture-proof coating layers can be molded to the mounted components by a local molding method to prevent moisture from being received to parts having an electrical characteristic.

According to an embodiment of the present invention, the LEDs can be mounted on the substrate and the moisture-proof coating layers can be molded to the metal parts outside the LEDs excluding the light emitting regions of the LEDs so that it is possible to provide a moisture resistant illuminating apparatus.

A diffusion plate (not shown) can be further attached in front of the illuminating apparatus 200 according to an embodiment of the present invention. The diffusion plate diffuses the light emitted from the LEDs to the entire surface so that light illuminates the inside with uniform brightness.

### Second Embodiment

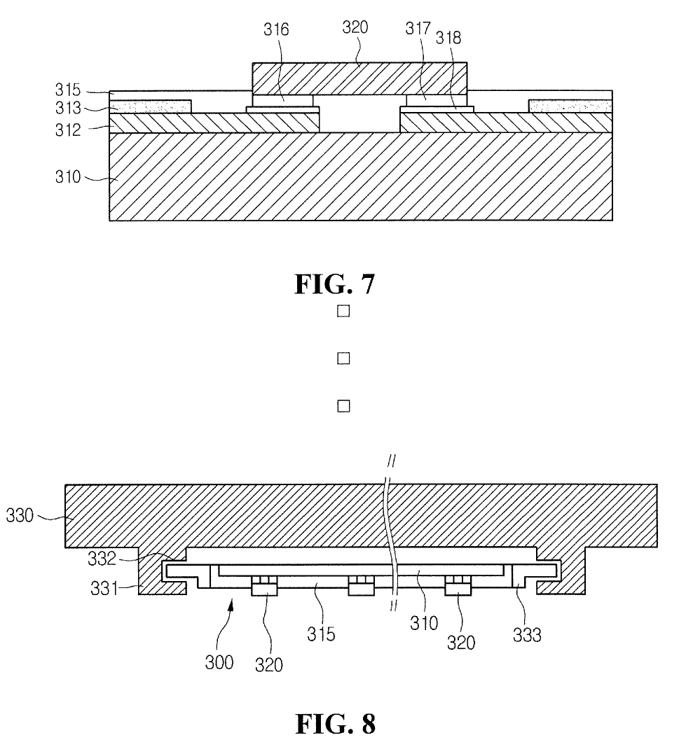

FIGS. 6 to 8 illustrate a second embodiment of the present invention. FIG. 6 is a plan view of an illuminating apparatus, FIG. 7 is a partial side sectional view of the illuminating apparatus, and FIG. 8 is a side sectional view illustrating an illuminating apparatus provided in a structure. For convenience, description of elements similar to those described with respect to the first embodiment will not be repeated.

Referring to FIG. 6, in an illuminating apparatus 300, at least one LED 320 can be arranged on a substrate 310. In an embodiment, the LEDs can be spaced apart from each other by a predetermined distance in a column formation. Since moisture-proof coating layers 315 are molded to the outside of the LEDs 320 and the surface of the substrate, it can be possible to protect parts having an electrical characteristic, such as lead patterns, and solder resist layers outside the LEDs 320 from outside environments.

Referring to FIG. 7, copper clad laminates can be attached on the substrate 310 to form lead patterns 312, and the substrate 310 on which the lead patterns 312 are formed can be coated with solder resist layers 313. The substrate 310 can be formed of FR-4 substrate so that it is not necessary to additionally form an insulating layer on the substrate.

The solder resist layers 313 formed on the substrate 310 can be partially etched to expose regions in which the LEDs 320 are mounted so that the lead patterns 312 are partially exposed. Electrode terminals 316 and 317 of the LEDs 320 can be bonded to the exposed lead patterns 312 by SMT using solders 318.

The moisture-proof coating layers 315 can be formed on the substrate. The moisture-proof coating layers 315 can be uniformly molded to the exposed parts of the lead patterns 312, the solder resist layers 313, the outside of the LEDs 320, and the bonded parts to have a predetermined height. That is, the moisture-proof coating layers 315 can be molded to the entire surface of the substrate excluding the light emitting regions of the LEDs 320.

The moisture-proof coating layers 315 can be formed of a moisture-proof coating material such as silicon. The silicon can be molded to the entire top surface of the substrate excluding the light emitting regions of the LEDs 320 using a syringe, and hardened at a predetermined temperature by a cure process. The moisture-proof coating layers 315 can prevent or inhibit the LEDs and peripheral metals from being damaged by moisture.

Referring to FIG. 8, the illuminating apparatus 300, in which the at least one LED 320 is provided, can be coupled with an inner structure 330 of a refrigerator. Fixed holders 331 can be formed to protrude on both sides of the inner structure 330, and grooves 332 can be formed in the fixed holders 331.

Supporting holders 333 that support both sides of the substrate of the illuminating apparatus 300 can be coupled with the grooves 332 of the fixed holders 331 so that the illuminating apparatus 300 is coupled with the structure 330. Here, the supporting holders 333 can be formed by using poly carbonate through a molding process.

In addition, in the illuminating apparatus 300, components (such as a constant current driving circuit and a controlling circuit) can be mounted on the substrate in order to uniformly supply a current to the LEDs 320 when the LEDs 320 are mounted on the substrate 310. Electric parts of the mounted components can be sealed through an entire surface molding method to shield moisture.

In an illuminating apparatus according to an embodiment, the height of the barrier ribs or the height of the moisture-proof coating layers can be controlled in accordance with the type of the LED package. In addition, a local molding method and an entire surface molding method can be used together for the illuminating apparatus.

Since an illuminating apparatus according to embodiments of the present invention can be provided in an inner structure in a humid and enclosed place or space, such as, for example, a refrigerator, a dish washer, underground facilities, a medical equipment deposit box, or an electric shaver deposit box, to radiate light with a wide beam angle, deviation in brightness can be small and illumination can be performed without tiring a person's eyes.

In addition, because the LED illuminating apparatus can rapidly reject heat, it is possible to obtain high optical efficiency with small power consumption.

In addition, it may be possible to prevent or inhibit the metals of an illuminating apparatus from being corroded, and to prevent or inhibit an electric short from being generated. Embodiments of the illuminating apparatus can be stably used in a humid and cold place or apparatus. Since LEDs having a long life and lower power consumption can be used for the illuminating apparatus, it is possible to improve the reliability of the illuminating apparatus.

In the above embodiments, when layers (films), regions, patterns, or elements are described in that they are formed on or under substrates, layers (films), regions, or patterns, it means that they are formed directly or indirectly on or under the substrates, layers (films), regions, or patterns.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modification in the component parts and/or arrangements, alternative uses will also be apparent to those skilled in the art.

What is claimed is:

1. A light emitting diode (LED) illuminating apparatus comprising:
a substrate;
at least one LED mounted on the substrate; and
a moisture-proof coating layer formed at an outer portion of the at least one LED.

2. The LED illuminating apparatus of claim 1, wherein the substrate comprises a metal substrate or a flame retardant (FR)-4 substrate.

3. The LED illuminating apparatus of claim 1, wherein a selected LED of the at least one LED comprises a package having at least one LED chip to emit white or color light.

4. The LED illuminating apparatus of claim 1, further comprising a metal member electrically connecting the substrate and a selected LED of the at least one LED to each other, wherein the moisture-proof coating layer covers the metal member.

5. The LED illuminating apparatus of claim 1, wherein the moisture-proof coating layer comprises silicon or epoxy.

6. The LED illuminating apparatus of claim 1, wherein the moisture-proof coating layer is locally molded on an outer circumference of a selected LED of the at least one LED or molded on an entire surface of the substrate.

7. The LED illuminating apparatus of claim 1, further comprising a barrier rib formed around the outer circumference of a selected LED of the at least one LED.

8. The LED illuminating apparatus of claim 7, wherein the barrier rib has a circular shape or a polygonal shape.

9. The LED illuminating apparatus of claim 7, wherein the barrier rib has a height sufficient for preventing the moisture-proof coating layer from overflowing.

10. The LED illuminating apparatus of claim 1, wherein the at least one LED is formed on the substrate in at least one column and/or row.

11. The LED illuminating apparatus of claim 1, wherein the substrate is provided on a structure or a holder in a humid space or a closed space.

12. The LED illuminating apparatus of claim 1, wherein the at least one LED mounted on the substrate comprises a plurality of LEDs connected to each other in series or in parallel.

13. A method of manufacturing an LED illuminating apparatus, comprising:
mounting at least one LED on a substrate; and
forming a moisture-proof coating layer at an outer portion of the at least one LED.

14. The method of claim 13, wherein forming the moisture-proof coating layer at an outer portion of the at least one LED comprises:
locally molding a moisture-proof coating material on electric parts around a selected LED of the at least one LED; or
molding a moisture-proof coating material on an entire surface of the substrate.

15. The method of claim 13, further comprising forming a barrier rib around an outer circumference of a selected LED with a height sufficient for preventing the moisture-proof coating layer from overflowing.

16. The method of claim 15, wherein the barrier rib has a circular shape or a polygonal shape around the outer circumference of the selected LED.

17. The method of claim 13, wherein the moisture-proof coating layer comprises silicon or epoxy.

18. The method of claim 13, wherein n a selected LED of the at least one LED comprises a package having at least on LED chip to emit white or color light.

19. The method of claim 13, wherein mounting at least one LED on the substrate comprises connecting a plurality of LEDs to each other in series or in parallel.

20. The method of claim 13, further comprising providing the substrate on a structure or a holder in a humid space or a closed space.
